(19) United States
(12) Patent Application Publication
(10) Pub. No.: US 2006/0286410 A1
(43) Pub. Date: Dec. 21, 2006

(54) Cemented carbide insert for toughness demanding short hole drilling operations

(75) Inventors: Mats Ahlgren, Taby (SE); Jan Kjellgren, Kista (SE); Torbjorn Agren, Falun (SE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB

(21) Appl. No.: 11/343,202

(22) Filed: Jan. 31, 2006

(30) Foreign Application Priority Data
Jan. 31, 2005 (SE) 0500234-0

(51) Int. Cl. B32B 9/00; B05D 3/00; C23C 8/00

(52) U.S. Cl. 428/698; 427/561; 427/585

(57) ABSTRACT

The present invention relates to a coated cutting insert with excellent toughness properties particularly useful for toughness demanding short hole drilling in low alloy and stainless steels and a method of making the same. The inserts comprise a substrate and a coating. The substrate comprises WC, from about 8 to about 11 wt-% Co and from about 0.2 to about 0.5 wt-% Cr with an average WC-grain size of from about 0.5 to about 1.5 μm and a CW-ratio of from about 0.80 to about 0.90. The coating comprises a laminar, multilayered structure of TiN+Ti₁₋ₓAlₓN+TiN+Ti₁₋ₓAlₓN+TiN . . . in polycrystalline, non-repetitive form, with x being from about 0.4 to about 0.6 with a thickness of the individual TiN—or Ti₁₋ₓAlₓN-layers of from about 1 to about 30 nm varying essentially at random and with a total thickness of the multilayered coating of from about 1 to about 5 μm. The layers are deposited using arc evaporation technique.

### BACKGROUND OF THE INVENTION

The present invention relates to a coated cutting tool insert particularly useful for toughness demanding short hole drilling in low alloy and stainless steels. The multilayer coating greatly improves both wear resistance and resistance against plastic deformation at high feeds combined with the low speeds close to the center of the drilled hole.

Drilling in metals is divided generally in two types: long hole drilling and short hole drilling. By short hole drilling is meant generally drilling to a depth of up to 3-5 times the drill diameter.

Long hole drilling puts large demands on good chip formation, lubrication, cooling and chip transport. This is achieved through specially developed drilling systems with specially designed drilling heads fastened to a drill rod and fulfilling the above mentioned demands.

In short hole drilling, the demands are not great, enabling the use of simple helix drills formed either of solid cemented carbide or as solid tool steel or of tool steel provided with a number of cutting inserts of cemented carbide placed in such a way that they together form the necessary cutting edge. In the center of the head, a tough grade of insert is sometimes used and on the periphery a more wear resistant one. The cutting inserts are brazed or mechanically clamped.

U.S. Pat. No. 6,103,357 relates to a cutting tool comprising a body of sintered cemented carbide or cermet, ceramic or high speed steel on which at least one of the functioning parts of the surface of the body, a thin, adherent, hard and wear resistant coating is applied. The coating comprises a laminar, multilayered structure of refractory compounds in polycrystalline, non-repetitive form, MX+NX+MX+NX where the alternating layers MX and NX are metal nitrides or carbides with the metal elements M and N selected from the group consisting of Ti, Nb, Hf, V, Ta, Mo, Zr, Cr, Al and W. The sequence of individual layer thicknesses is essentially aperiodic throughout the entire multilayered structure, and layer thicknesses are larger than 0.1 nm but smaller than 30 nm, preferably smaller than 20 nm. The total thickness of said multilayered coating is larger than 0.5 μm but smaller than 20 μm.

### OBJECTS AND SUMMARY OF THE INVENTION

It is an object of the present invention is to provide a coated cutting tool insert useful for toughness demanding short hole drilling in steel.

In one aspect of the invention, there is provided a cutting insert with excellent toughness properties comprising a substrate and a coating,

the substrate comprising WC, from about 8 to about 11 wt-% Co and from about 0.2 to about 0.5 wt-% Cr with an average WC-grain size of from about 0.5 to about 1.5 μm and a CW-ratio of from about 0.80 to about 0.90 and

the coating comprises a laminar, multilayered structure of TiN+Ti₁₋ₓAlₓN+TiN+Ti₁₋ₓAlₓN+TiN . . . in polycrystalline, non-repetitive form, x being equal to about 0.4 to about 0.6 with a thickness of the individual TiN— or Ti₁₋ₓAlₓN-layers of from about 1 to about 30 nm varying essentially at random, and with a total thickness of the multilayered coating of from about 1 to about 5 μm.

In another aspect of the invention, there is provided a method of making a cutting insert comprising a cemented carbide substrate and a coating, the substrate comprising of WC, from about 8 to about 11 wt-% Co and from about 0.2 to about 0.5 wt-% Cr with an average WC-grain size of from about 0.5 to about 1.5 μm and a CW-ratio of from about 0.80 to about 0.90 is coated with a coating comprising a laminar, multilayered structure of TiN+Ti₁₋ₓAlₓN+TiN+Ti₁₋ₓAlₓN+TiN . . . in polycrystalline, non-repetitive form, with x being from about 0.4 to about 0.6 with a thickness of the individual TiN— or Ti₁₋ₓAlₓN-layers of from about 1 to about 30 nm varying essentially at random, and with a total thickness of the multilayered coating of from about 1 to about 5 μm by cathodic arc evaporation using two pairs of arc sources of pure Ti and TiAl alloy, respectively in an N₂ gas atmosphere

### DETAILED DESCRIPTION OF THE PREFERRED EMBODIMENTS OF THE INVENTION

According to the invention, there is now provided cemented carbide inserts with excellent toughness properties particularly useful for toughness demanding short hole drilling in low alloy and stainless steels comprising WC and from about 8 to about 11 wt-% Co, preferably from about 9.5 to about 10.5 wt-% Co and from about 0.2 to about 0.5 wt-% Cr. The WC-grains have an average grain size of from about 0.5 to about 1.5 μm.

The amount of W dissolved in the binder phase is controlled by adjustment of the carbon content by small additions of carbon black or pure tungsten powder. The W-content in the binder phase can be expressed as the “CW-ratio” defined as
CW-ratio=M_{S}/(wt-% Co*0.0161)
where M_{S} is the measured saturation magnetization of the sintered cemented carbide body in hAm²/kg and wt-% Co is the weight percentage of Co in the cemented carbide. The CW-ratio in inserts according to the invention shall be from about 0.80 to about 0.90. Alternatively, the amount of W dissolved in the binder phase can be determined by use of a specific device which can read a specific magnetic saturation such as the Sigmameter of Setaram Instrumentation.

The coating comprises a laminar, multilayered structure of refractory compounds in polycrystalline, non-repetitive form, TiN+Ti₁₋ₓAlₓN+TiN+Ti₁₋ₓAlₓN+TiN . . . with x being equal to about 0.4 to about 0.6, preferably about 0.5. In said coating, the sequence of individual layer thicknesses has no repeat period but is essentially aperiodic throughout the entire multilayered structure. The individual TiN— or Ti₁₋ₓAlₓN-layer thickness is larger than about 1 nm but smaller than about 30 nm, preferably smaller than about 20 nm and varies essentially at random. The total thickness of the multilayered coating is greater than about 1 μm, preferably greater than about 2 μm but less than about 5 μm, preferably less than about 4 μm.

In one embodiment, there is an additional black, from about 0.2 to about 1 μm, preferably from about 0.3 to about 0.6 μm, thick Ti₁₋ₓAlₓN-layer on top of the multilayer coating.

In another embodiment, there is an additional bronze-colored homogeneous (Ti_{0.84}Al_{0.16})N-layer with a thickness of from about 0.2 to about 0.5, preferably about 0.3 μm on top of the multilayer coating.

The invention also relates to a method of making coated cemented carbide inserts with excellent toughness properties particularly useful for toughness demanding short hole drilling in low alloy and stainless steels. The cemented carbide comprises WC and from about 8 to about 11 wt-% Co, preferably from about 9.5 to about 10.5 wt-% Co and from about 0.2 to about 0.5 wt-% Cr. The WC-grains have an average grain size of from about 0.5 to about 1.5 μm. The raw materials powders are wet milled with a pressing agent, and small additions of carbon black or pure tungsten powder, if necessary, to obtain a CW-ratio in the sintered inserts of from about 0.80 to about 0.90. After the wet milling, the slurry is dried to a powder, compacted and sintered. After conventional post sintering treatment, a coating comprising a laminar, multilayered structure of refractory compounds in polycrystalline, non-repetitive form, TiN+Ti₁₋ₓAlₓN+TiN+Ti₁₋ₓAlₓN+TiN . . . with x being equal to about 0.4 to about 0.6, preferably about 0.5, is deposited by cathodic arc evaporation using two pairs of arc sources of pure Ti and TiAl alloy, respectively, in an N₂ gas atmosphere. In said coating, the sequence of individual layer thicknesses has no repeat period but is essentially aperiodic throughout the entire multilayered structure. The individual TiN— or Ti₁₋ₓAlₓN-layer thickness is larger than about 1 nm but smaller than about 30 nm, preferably smaller than about 20 nm and varies essentially at random. The total thickness of the multilayered coating is greater than about 1 μm, preferably greater than about 2 μm but less than about 5 μm, preferably less than about 4 μm.

In one embodiment, a final black from about 0.2 to about 1 μm, preferably from about 0.3 to about 0.6 μm, thick Ti₁₋ₓAlₓN-layer in the multilayer coating is deposited by cathodic arc evaporation using one pair of arc sources of a TiAl-alloy in an N₂ gas atmosphere.

In another embodiment, a final bronze-colored homogeneous (Ti_{0.84}Al_{0.16})N-layer with a thickness of from about 0.2 to about 0.5, preferably about 0.3 μm is deposited on top of the multilayer coating using arc deposition from an arc source consisting of a Ti_{0.84}Al_{0.16}-alloy in an atmosphere of Ar=400 sccm and N₂=800 sccm.

The invention is additionally illustrated in connection with the following examples, which are to be considered as illustrative of the present invention. It should be understood, however, that the invention is not limited to the specific details of the examples.

### EXAMPLE 1

Aperiodic multilayers were deposited by cathodic arc evaporation on drilling inserts made of cemented carbide with composition WC+10 wt-% Co and average WC grain size of 1.0 μm and a CW-ratio of 0.86. The coating was deposited from two pairs of arc sources consisting of pure Ti and TiAl alloy, respectively. The arc evaporation was performed in an N₂ gas atmosphere. The resulting total coating thickness was 3.0 μm, and consisted of a TiN+Ti_{0.5}Al_{0.5}N multilayer having a sequence of individual lamellae layers with an aperiodic, i.e., non-repetitive thickness. Cross section transmission electron microscopy investigation revealed that the individual nitride layer thicknesses ranged from 2 to 15 nm, and the total number of layers was about 400.

Half of the inserts were coated with an additional black Ti_{0.5}Al_{0.5}N-layer of about 0.3-0.6 μm thickness.

The other half of the inserts was coated with an additional homogeneous (Ti_{0.84}Al_{0.16})N-layer with a thickness of about 0.3 μm. This layer was deposited using arc evaporation from an arc source consisting of a Ti_{0.84}Al_{0.16}-alloy in an atmosphere of Ar=400 sccm and N₂=800 sccm. In this way a stable bronze color, on all inserts and also from batch to batch, was obtained.

### EXAMPLE 2

Bronze colored inserts from example 1 were tested and compared with inserts from Sandvik commercial grade 1020 with respect to toughness in a short hole drilling operation. The tested inserts were mechanically clamped on the center of the drill head. In the periphery, inserts from copending application filed concurrently herewith were used. Tool life criteria: crater wear, plastic deformation, flank wear, or chipping >0.25 mm.
Material: Low alloy steel SS2541-03, 285 HB.
Emulsion: Blasocut BC25, 7%.
Operation: Through hole, 48 mm.
Cutting speed: 260 m/min
Feed: 0.10 mm/r
Drill: Diameter 23 mm, 3×D
Insert style: CoroDrill 880, US0802C-GM

Results. A surprisingly significant difference in tool life, regarding crater wear resistance, was seen. The inserts according to the invention showed a much improved crater wear resistance compared to the inserts reference. Drilled length at tool life:
Invention inserts >40 meters
Reference insertstool failure after 30 meters

### EXAMPLE 3

Black inserts from Example 1 were tested and compared with inserts from Sandvik commercial grade 1020 with respect to toughness in a short hole drilling operation. The tested inserts were mechanically clamped on the periphery of the drill head. In the center, bronze colored inserts from Example 1 were used. Tool life criteria: crater wear, plastic deformation, flank wear, or chipping >0.25 mm.
Material: Low alloy steel SS2541-03, 270-285 HB.
Emulsion: Blasocut BC25, 7%.
Operation: Through hole, 50 mm.
Cutting speed: 200 m/min
Feed: 0.15 mm/r
Drill: Diameter 24 mm, 3×D
Insert style: CoroDrill 880, US0807P-GM
Results. Drilled length at tool life:
Inserts invention >20 meters
Inserts reference 13.3 meters

### EXAMPLE 4

Bronze colored inserts from Example 1 were tested and compared with inserts from Sandvik commercial grade 1020 with respect to toughness in a short hole drilling operation. The tested inserts were mechanically clamped on the center of the drill head. In the periphery, black inserts from Example 1 were used. Tool life criteria: crater wear, plastic deformation, flank wear, or chipping >0.25 mm.
Material: Low alloy steel SS2541-03, 300 HB.
Emulsion: Syntilo XPS, 6.5%, 10 bar.
Operation: Through hole, 40 mm.
Cutting speed: 150 m/min
Feed: 0.20 mm/r
Drill: Diameter 24 mm, 3×D
Insert style: CoroDrill 880, US0802C-GM

Results: At high feeds combined with the low speeds near the center of the hole the inserts invention showed a much improved wear resistance and resistance against plastic deformation compared to the inserts reference. Drilled length at tool life:
Inserts invention 13.5 meters
Inserts reference 2.3 meters

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. Cutting insert with excellent toughness properties comprising a substrate and a coating,
the substrate comprising WC, from about 8 to about 11 wt-% Co and from about 0.2 to about 0.5 wt-% Cr with an average WC-grain size of from about 0.5 to about 1.5 μm and a CW-ratio of from about 0.80 to about 0.90 and
the coating comprises a laminar, multilayered structure of TiN+Ti₁₋ₓAlₓN+TiN+Ti₁₋ₓAlₓN+TiN . . . in polycrystalline, non-repetitive form, with x being equal to about 0.4 to about 0.6 with a thickness of the individual TiN— or Ti₁₋ₓAlₓN-layers of from about 1 to about 30 nm varying essentially at random, and with a total thickness of the multilayered coating of from about 1 to about 5 μm.

2. A cutting insert of claim 1 wherein there is an additional black, from about 0.2 to about 1 μm thick, Ti₁₋ₓAlₓN-layer atop the multilayer coating.

3. A cutting insert of claim 1 wherein there is an additional bronze-colored homogeneous (Ti_{0.84}Al_{0.16})N-layer with a thickness of from about 0.2 to about 0.5 atop the multilayer coating.

4. A cutting insert of claim 1 wherein said substrate comprises from about 9.5 to about 10.5 wt-% Co.

5. A cutting insert of claim 1 wherein said coating comprises the said laminar, multilayered structure with x preferably about 0.5 and the thickness of the individual TiN— or Ti₁₋ₓAlₓN-layers are from about 1 to about 20 nm.

6. A cutting insert of claim 2 wherein the thickness of said additional black layer is from about 0.3 to about 0.6 μm.

7. A cutting insert of claim 3 wherein the thickness of said additional bronze-colored layer is about 0.3 μm.

8. Method of making a cutting insert comprising a cemented carbide substrate and a coating, the substrate comprising of WC, from about 8 to about 11 wt-% Co and from about 0.2 to about 0.5 wt-% Cr with an average WC-grain size of from about 0.5 to about 1.5 μm and a CW-ratio of from about 0.80 to about 0.90 is coated with a coating comprising a laminar, multilayered structure of TiN+Ti₁₋ₓAlₓN+TiN+Ti₁₋ₓAlₓN+TiN . . . in polycrystalline, non-repetitive form, with x being from about 0.4 to about 0.6 with a thickness of the individual TiN— or Ti₁₋ₓAlₓN-layers of from about 1 to about 30 nm varying essentially at random, and with a total thickness of the multilayered coating of from about 1 to about 5 μm by cathodic arc evaporation using two pairs of arc sources of pure Ti and TiAl alloy, respectively in an N₂ gas atmosphere.

9. A method of claim 5 further comprising depositing a final black from about 0.2 to about 1 μm, thick Ti₁₋ₓAlₓN-layer by cathodic arc evaporation using one pair of arc sources consisting of TiAl alloy in an N₂ gas atmosphere.

10. A method of claim 8 further comprising depositing a final bronze-colored homogeneous (Ti_{0.84}Al_{0.16})N-layer with a thickness of from about 0.2 to about 0.5 atop of the multilayer coating using arc evaporation from an arc source consisting of a Ti_{0.84}Al_{0.16}-alloy in an atmosphere of Ar=400 sccm and N₂=800 sccm.

11. A method of claim 8 wherein said substrate comprises from about 9.5 to about 10.5 wt-% Co.

12. A method claim 8 wherein said coating comprises the said laminar, multilayered structure with x preferably about 0.5 and the thickness of the individual TiN— or Ti₁₋ₓAlₓN-layers are from about 1 to about 20 nm.

13. A method of claim 9 wherein the thickness of said additional black layer is from about 0.3 to about 0.6 μm.

14. A method claim 10 wherein the thickness of said additional bronze-colored layer is about 0.3 μm.
